(19) United States
(12) Patent Application Publication
(10) Pub. No.: US 2011/0103384 A1
(43) Pub. Date: May 5, 2011

(54) ROUTING DEVICE AND METHOD OF CONFIGURATION FOR NETWORK NAME RESOLUTION OF SAME

(75) Inventors: Randy Wilfred HACKBART, Brnaby (CA); Kevin Russell Coates Lloyd, Poway, CA (US); Richard Thomas Kavanaugh, Encinitas, CA (US); Andrew Hasley Watson Mitchell, North Vancouver (CA)

(73) Assignee: Sierra Wireless, Inc.

(21) Appl. No.: 12/915,408

(22) Filed: Oct. 29, 2010

Related U.S. Application Data
(60) Provisional application No. 61/256,196, filed on Oct. 29, 2009.

(51) Int. Cl. H04L 12/56

(52) U.S. Cl. 370/392

(57) ABSTRACT

There is provided a routing device configured for operatively interconnecting a first digital data network (DDN) and a second DDN. The routing device comprises a first and second interface for operative connection with the respective first and second DDN and for transferring data packets associated with the first and second DDN. The routing device further comprises a processing system for processing the data packets and for transferring the data packets between the first interface and the second interface based upon address information encoded in the data packets. The processing system is configured with a routing device designation for identifying the routing device and a network address associated with the first DDN. Upon activation of the routing device, the processing system returns the network address in response to a network name resolution request for the routing device designation encoded in one or more first data packets characterized by one or more predetermined network protocols received from the first DDN.

### CROSS-REFERENCE TO RELATED APPLICATIONS

This application claims priority to U.S. Provisional Patent Application No. 61/256,196 filed Oct. 29, 2009, the content of which is incorporated herein by reference.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in the Patent and Trademark Office patent file or records, but reserves all other rights whatsoever.

### FIELD OF THE INVENTION

The present invention pertains in general to routing devices and in particular to aspects of accessing routing devices.

### BACKGROUND

State of the art routing devices for routing traffic on digital data networks typically provide a web or other network accessible user interface and possibly print server, file store or other network services that can be accessed, for example, from a client computing device within the network. Accordingly access to the user interface and/or other optional network services of a routing device is required for viewing and changing configuration data of the routing device as well as to enable optional other network services.

Remote access in state of the art digital data networks requires knowledge of the network address or the network name of the routing device. Network addresses are generally not considered intuitive and are often perceived as difficult to remember. Different routing devices are often configured with different network addresses making it even more difficult to identify the network address of a routing device.

Network access by network name, however, requires network name services for resolving the network name into a network address. Network name service including domain name service (DNS) or the name service provided by the Network Basic Input/Output System (NetBIOS), for example, require additional network components such as name servers and configuration which can further complicate network administration.

Network access to wireless routing devices can be further complicated as wireless devices additionally require further information including at least a network identifier and possibly access codes for establishing a wireless connection.

Therefore there is a need for a solution that aids in the simplification of network administration.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a routing device and method of configuration for network name resolution of same. In accordance with an aspect of the present invention, there is provided a routing device configured for operatively interconnecting a first digital data network (DDN) and a second DDN, the routing device comprising: a first interface for operative connection with the first DDN and for transferring data packets associated with the first DDN; a second interface for operative connection with the second DDN and for transferring data packets associated with the second DDN; and a processing system for processing the data packets and for transferring the data packets between the first interface and the second interface based upon address information encoded in the data packets; the processing system configured with a routing device designation for identifying the routing device; the processing system further configured with a network address associated with the first DDN, upon initial activation of the routing device the processing system configured to return the network address in response to a network name resolution request which uses the routing device designation (RDD) which is encoded in one or more first data packets characterized by one or more predetermined network protocols received from the first DDN.

In accordance with another aspect of the present invention there is provided a method for configuring a routing device for operatively interconnecting a first digital data network (DDN) and a second DDN, the routing device comprising a first interface for operative connection with the first DDN and for transferring data packets associated with the first DDN; a second interface for operative connection with the second DDN and for transferring data packets associated with the second DDN; and a processing system for processing the data packets and for transferring the data packets between the first interface and the second interface based upon address information encoded in the data packets; the method comprising: configuring the processing system with a routing device designation (RDD) for identifying the routing device; configuring the processing system to provide, upon initial activation of the routing device, a network address associated with the first DDN in response to a network name resolution request for the RDD that is encoded in one or more first data packets characterized by one or more predetermined network protocols received from the first DDN; whereby the RDD corresponds with the network name of the routing device.

In accordance with another aspect of the present invention, there is provided a computer readable memory having recorded thereon statements and instructions for execution by a computer to carry out the method for resolving a network name of a routing device configured for operatively interconnecting a first digital data network (DDN) and a second DDN, the routing device comprising a first interface for operative connection with the first DDN and for transferring data packets associated with the first DDN; a second interface for operative connection with the second DDN and for transferring data packets associated with the second DDN; and a processing system for processing the data packets and for transferring the data packets between the first interface and the second interface based upon address information encoded in the data packets; the method comprising: configuring the processing system with a routing device designation for identifying the routing device; configuring the processing system to provide, upon activation of the routing device, a network address associated with the first DDN in response to a network name resolution request for the routing device designation that is encoded in one or more first data packets characterized by one or more predetermined network protocols received from the first DDN; whereby the routing device designation corresponds with the network name of the routing device.

### BRIEF DESCRIPTION OF THE FIGURES

FIG. 1 illustrates a schematic network diagram including a routing device according to embodiments of the present invention.

FIG. 2 illustrates a block diagram of a routing device according to embodiments of the present invention.

FIG. 3 illustrates a flow diagram for an example name resolution process according to an embodiment of the present invention.

FIG. 4 illustrates a communication diagram of a routing device and corresponding method according to an embodiment of the present invention.

FIG. 5 illustrates a screenshot of a portion of a user interface for configuration of a routing device according to an embodiment of the present invention

### DETAILED DESCRIPTION OF THE INVENTION

### Definitions

As used herein, the term routing device designation “RDD” refers to a name or identifier associated with a routing device. The RDD can be a network name such as a host name, partially or fully qualified domain name, service set identifier (SSID), a predetermined name, random name or other name. The RDD may include one or more letters from one or more alphabets such as alphanumeric characters including characters from the Latin alphabet, or letters from other alphabets, symbols, digits, numbers or a combination thereof.

As used herein, the term “network name” can refer to a name of a device or to a name of a network depending on the context.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

A routing device according to the present invention can route digital network traffic and is configured to provide access to the routing device, for example for configuration, via a remotely accessible user interface without requiring knowledge of a first network address for association of the routing device with a first network and/or a second network address for association of the routing device with a second network by a user.

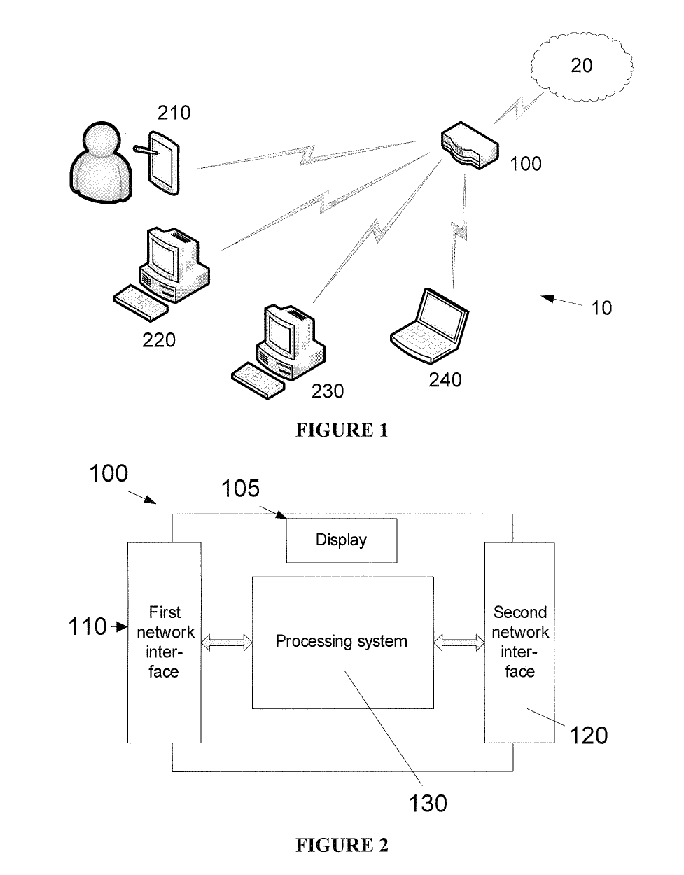

FIG. 1 illustrates a schematic diagram illustrating use of a routing device 100 according to embodiments of the present invention that is used to operatively interconnect the digital data networks (DDNs) 10 and 20. As illustrated, the DDN 10 may include one or more client computing devices, for example, handheld computing devices 210, personal computers 220, 230, notebook computers 240 and/or other computing devices.

Each of the DDNs 10 and 20 may be a wireless or wired local area network. The second DDN 20 may correspond with the Internet or a portion thereof and the first DDN 10 may correspond with a local area network (LAN). The routing device 100 may be configured to provide an up-link of a local area network to the Internet. The routing device 100 may be used without connection to the second DDN 20, in which case, the function of the routing device 100 may facilitate communication within the first DDN 10 without providing an operative connection with the second DDN 20. A routing device 100 according to embodiments of the present invention may provide all or a number of functions described herein irrespective of whether the routing device 100 is operatively associated with the second DDN 20.

FIG. 2 illustrates a block diagram of a routing device 100 according to embodiments of the present invention. The routing device 100 comprises a first interface 110 for operative connection with the first DDN and configured to transfer data packets associated with the first DDN. The routing device 100 further includes a second interface 120 for operative connection with the second DDN and configured to transfer data packets associated with the second DDN. In addition the routing device 100 includes a processing system 130 which is configured to process the data packets. The first interface 110 and the second interface 120 are operatively interconnected with the processing system 130. The first and second network interfaces 110 and 120 may be of the same or different types. For example, one network interface may be a wireless network interface, while the other network interface may be wired network interface, both network interfaces may be wired, or both network interfaces may be wireless. Under operating conditions, the processing system is configured to process received data packets and transfer them, if indicated by address information encoded in the data packets, between the first interface and the second interface. The routing device may have one or more network addresses associated with it, for example, the routing device may have a first network address for association with the first DDN and another network address for association with the second DDN. In some embodiments of the present invention, the routing device 100, includes a display 105, for example a LCD screen, lights or other configuration of a display, wherein the display can be operatively coupled to the processing system 130.

According to an embodiment of the present invention, the processing system is configured with a routing device designation (RDD) for identifying the routing device. The processing system is also configured to return a network address associated with the routing device in response to a network name resolution request from a computing device wherein the network name resolution request is at least in part based on the routing device designation together with one or more associated network protocols. According to an aspect of the present invention, the above network name resolution may be employed in network devices other than a routing device, for example, a camera, printer, file server, computing device or other device that can be operatively associated with a DDN. In some embodiments of the present invention, a display associated with the routing device, for example a display screen, can be used to identify or display the routing device designation of the routing device, thereby providing a potential user of the routing device with the “name” that can be used by their computing device for configuring a network name resolution request.

A name resolution request may be encoded in one or more first data packets characterized by one or more predetermined network protocols received by the routing device from the first DDN 10. The name resolution request may be performed using a number of network protocols, for example, using domain name resolution (DNS), NetBIOS or other protocol. This mechanism for obtaining a network address of the routing device can be used in a number of ways to enable and/or facilitate access to functions such as configuration data of the routing device, files or other functions provided by the routing device, for example, without requiring knowledge of the specific network address of the routing device. Once the network address of the routing device has been resolved, it may be used by the computing device that originally submitted the network name resolution request to address the routing device.

### Processing System and Routing Device Designation

The processing system may comprise a number of components including hardware such as one or more microprocessors and/or microcontrollers, volatile and/or non-volatile memory, and other components, as well as software and/or firmware for controlling the operation of the processing system and/or routing device. The operation of the routing device includes the control of flow of data packets and may at least in part be controlled based on configuration data stored in the routing device. The configuration data may be viewed and/or changed via one or more user interfaces.

According to an embodiment of the present invention, the processing system is configured to allow changing configuration data of the routing device including the routing device designation by a user via interaction with a user interface. The user interface may provide predetermined functions to facilitate access to the configuration data and/or changes thereof. Depending on the embodiment, the user interface may be configured as a web-based user interface. Furthermore, configuration data may be accessible via configuration text files, for example, from a command-line oriented user interface. The user interface may be accessible from the routing device directly or remotely from a computing device or terminal operatively connected to the routing device via the first DDN and/or the second DDN. The user interface may be accessible via one or more of a number of network protocols including http, https, ssh, telnet, bootp, tftp, ftp or other network programming interface technologies, for example.

According to an embodiment of the present invention, the configuration data includes the routing device designation. The routing device designation may be a name or identifier including one or more letters from one or more alphabets such as alphanumeric characters including characters from the Latin alphabet, or letters from other alphabets, symbols, digits, numbers or combinations thereof. The routing device designation may correspond with the network name or service set identifier (SSID) associated with the routing device, for example.

Depending on the embodiment, the routing device designation is determined in response to predetermined events, by software, firmware or hardware, during manufacture, or it may be otherwise determined. The routing device designation may be stored in the routing device, for example, in non-volatile and/or volatile memory within the processing system or elsewhere within the routing device. A routing device designation and/or network name of the routing device determined during or in effect of predetermined events such as during manufacture, may be saved in special, for example, read-only, otherwise-protected or other memory to prohibit it from being overwritten or to complicate the process of overwriting or changing it. Such memory may be one or more non-volatile memory including read-only memory (ROM), programmable ROM (PROM), electrically programmable ROM (EPROM), electrically erasable PROM, flash, dielectric, magnetic, or uninterruptedly-powered volatile memory, or other memory, for example. Depending on the embodiment, a routing devices designation may be saved in one or more locations in the routing device. For example, a factory default RDD may be stored in a location and/or memory different from an RDD operatively associated with the routing device at a given instance.

Depending on the embodiment, a determination of the RDD may or may not have an effect on one or more network names with which the routing device is associated in one or more DDNs. For example, a network name may refer to a DNS or NetBIOS name of the routing device in a given DDN. Depending on the embodiment, the routing device may be configured to derive parts or all of a network name of the routing device from the routing device designation or leave a network name as is. For this purpose the routing device may be configured with corresponding configuration data that can enable or disable a predetermined correlation between one or more network names of the routing device and the routing device designation or vice versa. Corresponding configuration data may be accessible by a user via a corresponding setting in the user interface. According to an embodiment of the present invention, the routing device may be configured to use equal terms for the RDD and a network name. For example, the routing device may be configured to use and/or copy the RDD into configuration data that corresponds with one or more network names, or read or derive the RDD and one or more of the network names from a common source item in the configuration data.

Depending on the embodiment, the routing device designation is determined arbitrarily by a user, or dynamically, or randomly, or independently of or based on other configuration data of the routing device or other information, and/or in another manner with or without interaction by a user, or by a combination thereof. The routing device designation may be determined by software, firmware or hardware within the routing device or within another device associated with the routing device. According to one embodiment, the routing device designation may be partially or fully derived from a model, make, type, serial number, Media Access Control (MAC) address or other qualifier associated with the routing device or combination thereof. According to one embodiment, the routing device designation may be determined based upon consideration of routing device designations associated with other routing devices. According to an embodiment, routing device designations of other routing devices may be determined by the instant routing device based on received radio signals or be determined otherwise. For example, an SSID of the routing device may be determined so all or part thereof is different from corresponding parts of sensed SSIDs of other devices that may have been discovered upon scanning for wireless networks by the routing device. The routing device designation may be determined based on a back-up routing device designation stored within memory within the routing device in effect of a partial or full reset to default, factory-default or other settings, for example.

Depending on the embodiment, if/when the routing device is configured to determine certain one or more network names associated therewith independent of the RDD, the routing device may be configured to determine these network names in a predetermined manner, upon occurrence of one or more predetermined events, or in likewise but independent and/or different manners as noted herein with respect to the RDD, for example.

Depending on the embodiment, the routing device may be configured to associate one or more network addresses with one or more network names of the routing device in the first and/or second DDN. According to an embodiment of the present invention, one or more network addresses of the routing device for association with the first DDN and/or the second DDN may be determined upon activation of the routing device or occurrence of predetermined events. According to an embodiment, the first network address may be selected from a predetermined set of network addresses and/or formats based on the type of the first DDN, for example an Internet Protocol Version 4 or Version 6 (IPv4 or IPv6) address. The first network address may be selected from a subset of IPv4 or IPv6 network addresses, for example, from a public IP network or a private IP network address space as defined by the Internet Engineering Task Force (IETF) memoranda RFC 1918 and RFC 4193. The first network address may be retained within the routing device 100 during deactivation of the routing device. The first network address may be stored in non-volatile memory within the processing system or elsewhere within the routing device. The routing device 100 may be associated with the first network address upon activation of the routing device.

A routing device in accordance with embodiments of the present invention may be configured so that a network name resolution process based on the RDD of the routing device can be successfully carried out by a computing device that is operatively associated with the routing device without requiring modification of the computing device. A routing device according to embodiments of the present invention may be configured to support network name resolution conforming to IETF guidelines. It is noted that corresponding steps may be performed in sequences as described herein or in other sequences depending on the configuration of the computing device, for example, without affecting the ability of the routing device to process network name resolution requests.

In general, network name resolution may be commenced when a network service request occurs. Network service requests may be invoked in a number of network devices including a computing device, a routing device according to embodiments of the present invention and/or other network devices, for example. Network service requests may be invoked by a user or occur as a consequence of invocations of software applications. A number of network service requests may cause generation of a network name resolution request. Different computing devices may invoke network service requests at different times. Furthermore, different network service requests may be dependent or independent of one another. Example network service requests that may cause a network name resolution request may include a http, https, ssh, telnet, remote execution, or NetBIOS service request or other request. As described herein, a network name resolution request may first be processed within the computing device and escalated if not resolved. If the network name resolution request cannot be successfully resolved within the computing device, the computing device may escalate the request to the routing device, and if required the routing device will escalate the request for processing by one or more adequately configured devices in one or more networks with which the routing device is operatively associated. Adequately configured devices may include one or more domain name servers (DNS) or Windows™ Internet Name Service (WINS) servers, for example.

According to an embodiment of the present invention, a routing device that provides a wireless network interface may be configured with a RDD corresponding to its SSID. This configuration may reduce the amount of information required to be memorized by a user and thereby simplify access to a wireless routing device. According to an embodiment of the present invention, a routing device may be configured with a mnemonic RDD. It is further noted that a routing device may be configured to return its network address in response to a network name resolution request configured using its RDD via one or more of its network interfaces. It is further noted that a routing device according to an embodiment of the present invention, may return the network address with which it is associated via the network interface through which the routing device receives a network name resolution request configured using its RDD.

The invention will now be described with reference to a specific example. It will be understood that the example is intended to describe aspects of some embodiments of the invention and is not intended to limit the invention in any way.

### Example

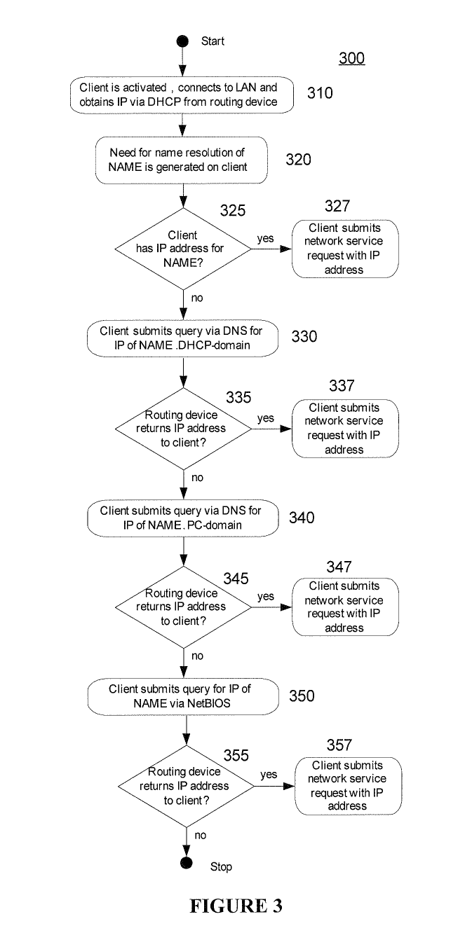

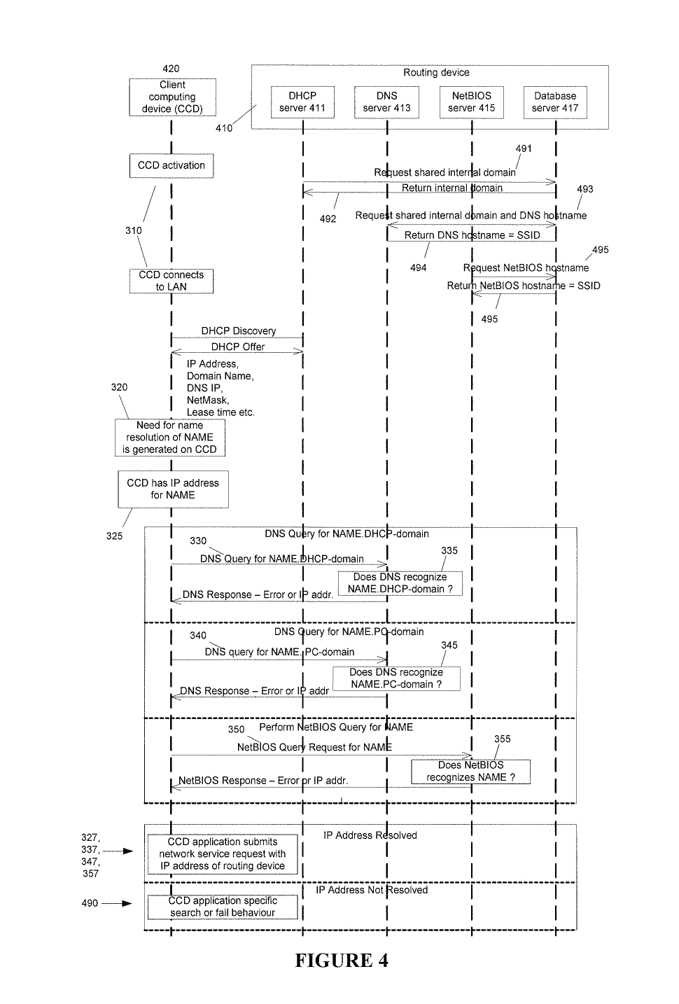

FIG. 3 and FIG. 4 illustrate an example network name resolution process for a routing device according to an embodiment of the present invention. The network name resolution process involves communication between an example client computing device (CCD) 420 and an example routing device 410. The CCD 420 may generate and submit a number of network name resolution requests as described herein. The routing device 410 is configured, in accordance with embodiments of the present invention, to process and/or, if necessary, forward network name resolution requests via DNS or NetBIOS as well as to return corresponding replies, if any. The routing device 410 is further configured to answer network name resolution requests seeking to resolve the RDD.

FIG. 3 illustrates a flow diagram of a network name resolution process for a routing device according to an embodiment of the present invention. FIG. 4 illustrates a block diagram of the routing device 410 and communications between the CCD 420 and the routing device 410 as well as communications that occur as part of the network name resolution process within the routing device 410. FIG. 4 illustrates communications occurring along a timeline that progresses downwards as time advances. The routing device 410 comprises a DHCP server application 411, a DNS server application 413, a NetBIOS server application 415 and a database server application 417, which are operatively associated. The database server application 417 is configured as a text file which includes configuration data for the routing device 410 in a predetermined format. The database server application 417 can be configured in other manners, depending on the embodiment.

The DHCP server application 411, the DNS server application 413, and the NetBIOS server 415 are configured to obtain predetermined network configuration data including the domain name, DNS and NetBIOS hostname for association of the routing device 410 with the first DDN from database server application 417, for example during initialization or as a consequence of reconfiguration of the routing device 410. As the routing device 410 is configured with a RDD corresponding to its SSID, the DNS and NetBIOS hostname correspond with the SSID. The routing device 410 is configured to obtain the network configuration data by submitting requests 491, 493 and 495 to database server 417, which is configured to return corresponding answers in its replies 492, 494 and 496 to the requests 491, 493 and 495 as illustrated in FIG. 4.

The example network name resolution process may involve invocation of a number of steps in a requesting CCD and in the routing device with which the requesting CCD is operatively associated in a networked fashion. It is noted that the number of steps that need to be carried out in order to resolve and complete the network name resolution request at least in part using the RDD of a routing device may be different for different CCDs and/or for different network name resolution requests for the same CCD and/or for different CCDs.

Step 310, shown in FIG. 3, includes activation of the CCD and connection of the CCD to a local area network (LAN). Step 310 may be considered indirectly associated with and/or outside of the steps immediately involved in the network name resolution process. Connection of the CCD to or operative association of the CCD with the LAN may involve operatively attaching the CCD to the network with a network cable or configuring the CCD with wireless configuration data for associating the CCD with the routing device. The configuration data for association with a wireless routing device may include specification of one or more of a SSID, one or more network encryption methods, one or more passphrases or other keys, and/or other information on the CCD, for example.

Step 310 may further include obtaining an IP address and other network address configuration data for use by the CCD. The network address configuration data may be obtained by the CCD using a dynamic host configuration protocol (DHCP) from the DHCP server application 411 of the routing device 410 or using static network configuration stored within the CCD. Once the CCD has been configured with the network configuration data, the CCD can formulate adequately formatted headers for IP packets.

The DHCP server application 411 may provide various network configuration data for use by a CCD upon completion of a successful DHCP request including an IP address, gateway address, one or more DNS server addresses, a netmask, DHCP lease time and/or other network configuration data as would be readily understood by a person skilled in the art. Respective addresses may be formatted according to IP Version 4 or IP Version 6 depending on the configuration of the corresponding network.

Step 320 includes generation of a need for a network name resolution on the CCD. This may include entering “NAME” in the address bar of a web or file browser, for example, or invoking various kinds of application software on the CCD with “NAME” as a parameter that is intended to refer to a network name of a network device. The need may cause generating a network name resolution request based on “NAME”. A network name resolution request may seek to resolve the network name “NAME” or a network name based on “NAME” that may further include other elements, which may be added by application software or operating system routines of the CCD as part of the generation of a network name resolution request.

Step 325 includes determination of whether the CCD has a valid network address associated with the network name “NAME” entered in Step 320. This may be performed in a number of ways, for example, by the application software with which the need for the network name resolution was generated, by name resolution software that may be invoked on the CCD as a consequence of Step 320, by the operating system on the CCD, or by other software, firmware, or hardware. If the CCD determines a valid network address for “NAME” internally without submitting a name resolution request to the network, the name resolution process proceeds to submitting a network service request with the determined network address in Step 327. If it doesn't, the name resolution process proceeds to Step 330.

If the name resolution process proceeds to Step 330, the CCD generates and submits a network name resolution request in form of a query for a fully qualified domain name (FQDN) corresponding to “NAME.DHCP-domain” via DNS. In accordance with the network name resolution process 300, the DHCP-domain may have been determined in Step 310, for example, from a response to a DHCP request by the CCD or from other information retained by the CCD.

In Step 335 it is determined if the network name encoded in the DNS request submitted in Step 330 corresponds with the RDD. This step is performed in the routing device and controlled by DNS server application software 413. If the network name resolution request corresponds with the RDD, the routing device 410 will return its network address to the requesting CCD and the CCD will submit a corresponding network service request with the discovered network/IP address in Step 337. If the network name resolution request does not correspond with the RDD, the routing device will not directly answer the request, but forward the network name resolution request in a preconfigured manner according to IETF DNS guidelines, for example. If the network name resolution request of Step 330 is not resolved, the network name resolution process proceeds to Step 340.

In Step 340 a network name resolution request similar to the one of Step 330 is generated by the CCD. Step 340, differs from Step 330 in that the domain portion of the FQDN used in the network name resolution request corresponds with the PC-domain instead of the DHCP-domain. That is the FQDN of Step 340 corresponds with “NAME.PC-domain”. The PC-domain may correspond with a domain with which the CCD is associated through means other than by its interaction with a DHCP server, for example, through association with a Windows™ Internet Name Service (WINS) or other network name service. The actions performed in subsequent Steps 345 and 347 correspond with the actions performed in respective Steps 335 and 337 described herein. If the network name resolution request of Step 340 is not resolved, the network name resolution process proceeds to Step 350.

As shown in Step 350, the CCD may generate another network name resolution request similar to the one of Step 330. Step 350, differs from Step 330 in that, a network name resolution request based on “NAME” (as illustrated), a FQDN (not illustrated) or another domain name (not illustrated) based on “NAME”, for example, is generated by the CCD and submitted via NetBIOS as a NetBIOS Name Service (NBNS) request to the routing device 410.

In Step 355 it is determined if the network name encoded in the NBNS request submitted in Step 350 corresponds with the RDD. This step is performed in the routing device 410 by corresponding NetBIOS server application 415. If the network name of the NBNS request corresponds with the RDD, the routing device will return its network address to the requesting CCD as a NBNS response and the CCD will submit a corresponding network service request with the discovered network/IP address in Step 357. If the NBNS request does not correspond with the RDD, the routing device will not further process the request, but may forward the NBNS request in a preconfigured manner according to NBNS guidelines, for example. If the network name resolution request of Step 350 is not resolved the network name resolution process remains unsuccessful as indicated by 490 in FIG. 4 and the application which originally generated the need for the network name resolution request will respond in a preconfigured manner.

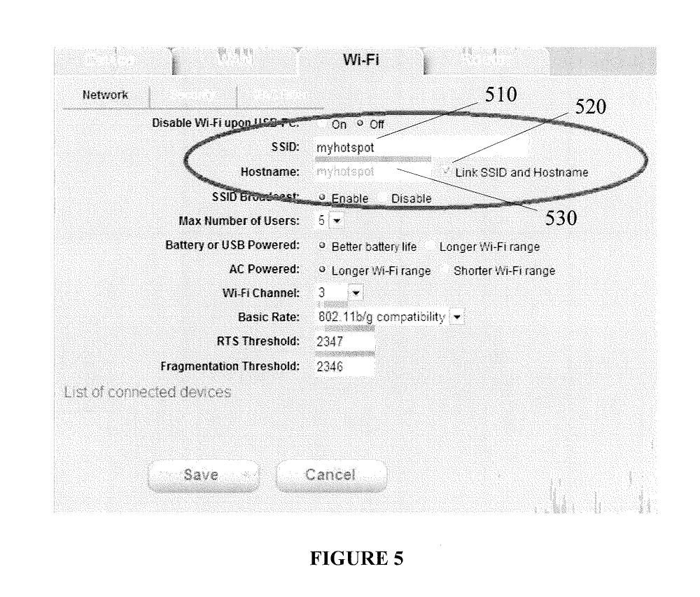

FIG. 5 illustrates a portion of the user interface of the routing device 410 showing a certain configuration data including a number of wireless network settings of the routing device 410. The routing device 410 is configured as a wireless (WiFi) routing device using the SSID 510 as a routing device designation. The network name with which the routing device 410 is associated within the WiFi network is indicated as “Hostname” 530 and the routing device 410 is configured to enable/disable linkage of the Hostname 530 to the SSID 510. As illustrated, when the Hostname is linked to the SSID, by activating the checkbox 520 entitled “Link SSID and Hostname”, the same term used for the SSID is used for the network name of the routing device 410. The routing device 410 is configured so that when the “Link SSID and Hostname” checkbox 520 is activated, the Hostname 530 becomes identical to the SSID 510, any changes to the SSID 510 are automatically reflected in the Hostname 530, the Hostname 530 can no longer be edited, and, furthermore, the font for the Hostname 530 changes from black to a grey color in order to provide a visual indication that the Hostname 530 is locked.

For illustrative purposes, the routing device 410 is configured with the SSID 510 set to “myhotspot” and the “Link SSID and Hostname” checkbox 520 activated, which may be default settings of the routing device 410 in effect of a factory setting, for example. In addition to FIG. 5, the routing device 410 can be configured (not illustrated) to generate a SSID comprising a combination of a predetermined term and a number. The number may comprise a predetermined quantity of digits, and may be random or derived from a MAC address or serial number associated with the routing device 410, for example, which may help avoid collisions of SSIDs with other nearby routing devices. An example SSID may be “myhotspot-379”, “ProductName-872”, other term, or other at least in part mnemonic term. The routing device 410 is further configured to allow the Hostname 530 to be set independently of the SSID 510, by “unchecking” the “Link SSID and Hostname” checkbox 520 and changing the Hostname 530 as desired, by a user. It is noted that the SSID 510 may only include certain characters. The routing device 410 may be configured to activate changes to the noted settings upon saving or require occurrence of a subsequent update event, for example, passage of a predetermined amount of time, or occurrence of a predetermined event in effect of a predetermined user interaction with user interface.

The routing device 410 may further be configured to use the SSID as a NetBIOS name of the routing device (not illustrated). In this case, the routing device 410 may be configured to enable/disable linkage of the NetBIOS name to the SSID similarly to the linkage between the Hostname and the SSID described herein. It is noted that the mapping of the SSID to the NetBIOS name may be employed within limitations, because NetBIOS names are case insensitive whereas SSIDs are case sensitive.

The routing device 410 may further be configured to provide Common Internet File System (CIFS) services. CIFS, which is also referred to as Server Message Block (SMB) may be provided based on the NetBIOS network interface including NetBIOS name resolution. CIFS/SMB services, however, do not require NetBIOS. It is noted that a routing device may be configured to provide CIFS/SMB services but not provide NetBIOS name resolution. The routing device 410 may be configured to provide CIFS/SMB services including file, printer, WINS or other CIFS/SMB services.

The user interface illustrated in FIG. 5 may be configured as a web-accessible user interface, which may consequently be accessible via http://myhotspot and/or https://myhotspot on a CCD. Similarly, server message block services may be accessible by entering \\myhotspot in respective applications on a CCD, provided that the routing device 410 is configured to provide these network services. It is noted that routing devices according to other embodiments of the present invention may be configured with other formats of one or more RDDs.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as a personal computer, server or the like and pursuant to one or more, or a part of one or more, program elements, modules or objects generated from any programming language, such as C, C++, Java, Perl, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A routing device configured for operatively interconnecting a first digital data network (DDN) and a second DDN, the routing device comprising:
a. a first interface for operative connection with the first DDN and for transferring data packets associated with the first DDN;
b. a second interface for operative connection with the second DDN and for transferring data packets associated with the second DDN; and
c. a processing system for processing the data packets and for transferring the data packets between the first interface and the second interface based upon address information encoded in the data packets; the processing system configured with a routing device designation for identifying the routing device; the processing system further configured with a network address associated with the first DDN, upon initial activation of the routing device the processing system configured to return the network address in response to a network name resolution request which uses the routing device designation (RDD) which is encoded in one or more first data packets characterized by one or more predetermined network protocols received from the first DDN.

2. The routing device according to claim 1, wherein the one or more predetermined network protocols include at least one protocol selected from the group comprising NetBIOS and DNS.

3. The routing device according to claim 2, wherein the first DDN is a wireless network and the RDD corresponds with the service set identifier (SSID) of the routing device.

4. The routing device according to claim 1, wherein the RDD for identifying the routing device is preconfigured during manufacture of the routing device.

5. The routing device according to claim 3 further comprising one or more server applications selected from the group comprising NetBIOS server application and DNS server application.

6. The routing device according to claim 5, wherein each of the one or more server applications is configured to associate a corresponding network name with the routing device that equals the SSID based upon predetermined configuration data.

7. The routing device according to claim 6 further comprising a user interface, wherein the predetermined configuration data is user configurable via the user interface.

8. The routing device according to claim 7, wherein the predetermined configuration data can be configured by a user via one or more checkboxes included in the user interface, each check box corresponding with one of the server applications.

9. The routing device according to claim 7, wherein the predetermined configuration data is included in a text file and can be configured by a user via editing of the text file.

10. The routing device according to claim 4, wherein the RDD comprises a predetermined term.

11. The routing device according to claim 4, wherein the RDD comprises a number with a predetermined quantity of digits.

12. The routing device according to claim 4, wherein the RDD comprises a predetermined term and a number with a predetermined quantity of digits.

13. The routing device according to claim 4, wherein the RDD is determined based on a serial number associated with the routing device.

14. The routing device according to claim 4, wherein the RDD is determined based on a Media Access Control (MAC) address associated with the routing device.

15. The routing device according to claim 3, wherein the SSID of the routing device is determined based upon results obtained from a scan performed by the routing device for SSIDs associated with other wireless devices and the SSID of the routing device is chosen to avoid conflict with the results.

16. A method for configuring a routing device for operatively interconnecting a first digital data network (DDN) and a second DDN, the routing device comprising a first interface for operative connection with the first DDN and for transferring data packets associated with the first DDN; a second interface for operative connection with the second DDN and for transferring data packets associated with the second DDN; and a processing system for processing the data packets and for transferring the data packets between the first interface and the second interface based upon address information encoded in the data packets; the method comprising:
a. configuring the processing system with a routing device designation (RDD) for identifying the routing device;
b. configuring the processing system to provide, upon initial activation of the routing device, a network address associated with the first DDN in response to a network name resolution request for the RDD that is encoded in one or more first data packets characterized by one or more predetermined network protocols received from the first DDN;
whereby the RDD corresponds with the network name of the routing device.

17. The method according to claim 16, wherein the one or more predetermined network protocols include at least one protocol selected from the group comprising NetBIOS and DNS.

18. The method according to claim 17, wherein the first DDN is a wireless network and the RDD corresponds with the service set identifier (SSID) of the routing device.

19. The method according to claim 16, wherein the RDD for identifying the routing device is preconfigured during manufacture of the routing device.

20. The method according to claim 18, wherein the routing device further comprises one or more server applications selected from the group comprising NetBIOS server application and DNS server application.

21. The method according to claim 20, wherein each of the one or more server applications is configured to associate a corresponding network name with the routing device that equals the SSID based upon predetermined configuration data.

22. The method according to claim 21, wherein the routing device further comprises a user interface, and the predetermined configuration data is user configurable via the user interface.

23. The method according to claim 22, wherein the predetermined configuration data can be configured by a user via one or more checkboxes included in the user interface, each check box corresponding with one of the server applications.

24. The method according to claim 22, wherein the predetermined configuration data is included in a text file and can be configured by a user via editing of the text file.

25. The method according to claim 19, wherein the RDD comprises a predetermined term.

26. The method according to claim 19, wherein the RDD comprises a number with a predetermined quantity of digits.

27. The method according to claim 19, wherein the RDD comprises a predetermined term and a number with a predetermined quantity of digits.

28. The method according to claim 19, wherein the RDD is determined based on a serial number associated with the routing device.

29. The method according to claim 19, wherein the RDD is determined based on a Media Access Control (MAC) address associated with the routing device.

30. The method according to claim 18, wherein the SSID of the routing device is determined based upon results obtained from a scan performed by the routing device for SSIDs associated with other wireless devices, and the SSID of the routing device is chosen to avoid conflict with the results.

31. A computer readable memory having recorded thereon statements and instructions for execution by a computer to carry out the method for resolving a network name of a routing device configured for operatively interconnecting a first digital data network (DDN) and a second DDN, the routing device comprising a first interface for operative connection with the first DDN and for transferring data packets associated with the first DDN; a second interface for operative connection with the second DDN and for transferring data packets associated with the second DDN; and a processing system for processing the data packets and for transferring the data packets between the first interface and the second interface based upon address information encoded in the data packets; the method comprising:
a. configuring the processing system with a routing device designation for identifying the routing device;
b. configuring the processing system to provide, upon activation of the routing device, a network address associated with the first DDN in response to a network name resolution request for the routing device designation that is encoded in one or more first data packets characterized by one or more predetermined network protocols received from the first DDN;
whereby the routing device designation corresponds with the network name of the routing device.
